(19) United States
(12) Patent Application Publication
(10) Pub. No.: US 2025/0282919 A1
(43) Pub. Date: Sep. 11, 2025

(54) PROCESS FOR PRODUCING A MULTIMODAL POLYOLEFIN COMPOSITION IN AN EXTRUDER DEVICE

(71) Applicant: Basell Polyolefine GmbH, Wesseling (DE)

(72) Inventors: Marco Consalvi, Ferrara (IT); Lorenzo Borsoi, Ferrara (IT); Decio Malucelli, Ferrara (IT)

(73) Assignee: Basell Polyolefine GmbH, Wesseling (DE)

(21) Appl. No.: 18/863,731

(22) PCT Filed: May 10, 2023
(86) PCT No.: PCT/EP2023/062418

§ 371 Date: Nov. 7, 2024

(30) Foreign Application Priority Data
May 13, 2022 (EP) 22173353.8

(51) Int. Cl. C08J 3/20; B29C 48/04; B29C 48/09; B29C 48/405; B29K 23/00; B29L 23/00; C08F 2/01; C08F 2/34; C08F 4/02; C08F 210/16; C08J 3/12; C08J 3/22; C08K 5/14

(52) U.S. Cl. CPC C08J 3/203; B29C 48/04; B29C 48/09; B29C 48/405; C08F 2/01; C08F 2/34; C08F 4/022; C08F 210/16; C08J 3/12; C08J 3/22; C08K 5/14; B29K 2023/08; B29K 2995/0063; B29L 2023/22; C08J 2323/08

(57) ABSTRACT

A continuous process for preparing a multimodal polyolefin composition made from or containing one or more antioxidants, including the steps of: preparing a multimodal polyolefin in form of a polyolefin powder, having a mass-median-diameter D50 in the range from 300 μm to 2500 μm, in a series of polymerization reactors; mixing the polyolefin powder and an organic peroxide without melting the polyolefin powder; melting and homogenizing the mixture within an extruder device; adding one or more antioxidants to the molten polyolefin composition; homogenizing the combination of molten polyolefin composition and antioxidant, thereby forming an antioxidant equipped molten polyolefin composition; and pelletizing the antioxidant equipped molten polyolefin composition.

### FIELD OF THE INVENTION

In general, the present disclosure relates to the field of chemistry. More specifically, the present disclosure relates to polymer chemistry. In particular, the present disclosure provides a continuous process for preparing a multimodal polyolefin composition made from or containing an antioxidant.

### BACKGROUND OF THE INVENTION

In some instances, polyolefins are combined with additional substances, thereby providing certain properties. These plastics additives are added in small quantities and influence the properties of the polymers, thereby rendering the polymers commercially useful. In some instances, the additives are combined with the polyolefins directly after the polyolefins' polymerization and during the pelletizing step. A kind of additives are antioxidants. These polymer additives suppress degradation of the polymers caused by reaction with atmospheric oxygen. Antioxidants are effective in the stages of the polymer life-cycle. Antioxidants allow the production of plastic articles faster with fewer defects, extend the useful lifespan of the articles, and facilitate recycling.

A kind of additives are free radical generators such as peroxides. In some instances, free radical generators modify the molecular structure of the polyolefins.

In some instances, polyolefins are used to prepare pipes, including pressure pipe. As used herein, the term “pressure pipe” refers to pipes designed to transport fluids at conditions having a higher pressure inside the pipe than outside the pipe. In some instances, the polyolefins are bimodal or multimodal polyethylenes, having a density from 0.940 g/cm³ to 0.968 g/cm³.

For pipe applications, the polyethylenes should demonstrate adequate extrusion processability and avoid sagging. As used herein, the term “sagging” refers to the effect that, during melt extrusion of the pipe, a portion of the melt flows from an upper part of the pipe to a lower part of the pipe, thereby resulting in pipe-wall-thickness variation around the pipe circumference.

In some instances and to improve the sagging behavior of pipes produced form bimodal or multimodal polyethylenes, peroxides are added in the pelletizing of the bimodal or multimodal polyethylenes.

### SUMMARY OF THE INVENTION

In a general embodiment, the present disclosure provides a continuous process for preparing a multimodal polyolefin composition made from or containing one or more antioxidants, including the steps of:
a) preparing a multimodal polyolefin in form of a polyolefin powder, having a mass-median-diameter D50 in the range from 300 μm to 2500 μm, in a series of two or more polymerization reactors by polymerizing one or more 1-olefins in the presence of an olefin polymerization catalyst at pressures from 0.5 MPa to 10 MPa and temperatures from 30° C. to 160° C., wherein the multimodal polyolefin being a multimodal polyethylene;
b) providing an organic peroxide in an amount from 20 ppm to less than 100 ppm, with respect to the polyolefin powder;
c) mixing the polyolefin powder and the organic peroxide at a temperature in the range from 10° C. to 100° C., without melting the polyolefin powder, thereby forming a polyolefin peroxide mixture;
d) melting and homogenizing the polyolefin peroxide mixture within an extruder device, wherein at least 90 wt. % of the organic peroxide decomposes, thereby forming a molten polyolefin composition;
e) adding one or more antioxidants to the molten polyolefin composition, thereby forming a combination of molten polyolefin composition and antioxidant;
f) homogenizing the combination of molten polyolefin composition and antioxidant, thereby forming an antioxidant equipped molten polyolefin composition; and
g) pelletizing the antioxidant equipped molten polyolefin composition. In some embodiments, the organic peroxide is provided in an amount from 20 ppm to less than 100 ppm, alternatively from 25 ppm to 95 ppm, alternatively from 28 ppm to 80 ppm, with respect to the polyolefin powder.

In some embodiments, the multimodal polyolefin is prepared in one or more gas-phase polymerization reactors, wherein at least one of the gas-phase polymerization reactors is a multizone circulating reactor. A polymerization zone is a riser, wherein growing polymer particles flow upwards under fast fluidization or transport conditions. The other polymerization zones are sub-zones of a downcomer, wherein the growing polymer particles flow downward in a densified form. The riser and the downcomer are interconnected. After leaving the riser, polymer particles enter the downcomer. After leaving the downcomer, polymer particles enter the riser. A circulation of polymer particles through the riser and the downcomer is established.

In some embodiments, the series of polymerization reactors includes a fluidized-bed reactor upstream of the multizone circulating reactor.

In some embodiments, the olefin polymerization catalyst is a Ziegler- or Ziegler-Natta-catalyst made from or containing the reaction product of an aluminum alkyl with a titanium compound supported on a magnesium halide.

In some embodiments, the extruder device is a combination of two co-rotating twin-screw extruders, wherein the polyolefin powder and the organic peroxide are transferred into a first twin-screw extruder, in which step d) is carried out, and the second twin-screw extruder receives the combination of molten polyolefin composition and antioxidant and carries out step f). In some embodiments, the extruder device is a counter-rotating continuous mixer equipped with gear pump. In some embodiments, the extruder device is a co-rotating twin screw extruder equipped with gear pump.

In some embodiments, the antioxidant equipped molten polyolefin composition is passed through a melt filter before being pelletized.

In some embodiments, the multimodal polyolefin and the organic peroxide are supplied to a mixing device and the mixing of step c) occurs in the mixing device.

In some embodiments, the multimodal polyolefin is supplied directly to the extruder device. In some embodiments, the multimodal polyolefin is supplied to a mixing device, mixed therein with one or more additives different from antioxidants and organic peroxides, thereby providing a mixture. In some embodiments, the mixture is transferred from the mixing device into the extruder device. In some embodiments, the organic peroxide provided in step b) is supplied to the extruder device at a position where the multimodal polyolefin or the mixture is not yet molten.

In some embodiments, the mixing of step c) is carried out in an atmosphere of reduced oxygen content, wherein the oxygen content in the gas phase within the mixing device is less than 5 vol %.

In some embodiments, in step b), the organic peroxide is provided as a liquid, as a component of a liquid, or as a mixture of the organic peroxide with a polyolefin powder.

In some embodiments, in step b), the organic peroxide is provided as a liquid or as a component of a liquid, wherein the liquid is added to the polyethylene powder by injecting the liquid with an injection pressure of 0.5 to 4 MPa through a spring injector having a preloaded spring.

In some embodiments, the organic peroxide is provided as a peroxide solution, having a content of active oxygen in the range from 0.1 wt. % to 10 wt. %.

In some embodiments, the multimodal polyolefin has a M_{w}/Mₙ from 15 to 40.

In some embodiments, the multimodal polyolefin prepared in step a) is a multimodal polyethylene, alternatively a multimodal polyethylene, having a density determined according to DIN EN ISO 1183-1:2004 at 23° C. from 0.940 g/cm³ to 0.968 g/cm³.

In some embodiments, the present disclosure provides a process for preparing a pipe including the steps of
a) preparing a multimodal polyolefin composition; and
b) forming the multimodal polyolefin composition into a pipe.

### BRIEF DESCRIPTION OF THE DRAWINGS

FIG. 1 shows a schematic of a reactor for preparing bimodal or multimodal polyethylenes.

FIG. 2 shows a schematic of a spring injector for adding a liquid made from or containing an organic peroxide to a polyethylene powder.

FIG. 3 shows a schematic of a process for preparing a polyolefin composition, wherein a liquid made from or containing an organic peroxide is added to a polyolefin powder in a mixing device and a masterbatch of one or more antioxidants is added to the molten and homogenized mixture of polyolefin powder and peroxide solution.

FIG. 4 shows a schematic of a process for preparing a polyolefin composition, wherein a liquid made from or containing an organic peroxide is added to a polyolefin powder in an extruder device and a masterbatch of one or more antioxidants is added to the molten and homogenized mixture of polyolefin powder and peroxide solution.

FIG. 5 shows a schematic of a process for preparing a polyolefin composition, wherein a liquid made from or containing an organic peroxide and a mixture of additive made from or containing one or more antioxidants are added to a polyolefin powder in a mixing device.

### DETAILED DESCRIPTION OF THE INVENTION

In some embodiments, the present disclosure provides a continuous process for preparing a multimodal polyolefin composition made from or containing one or more antioxidants. In some embodiments, the process includes, as step a), preparing a multimodal polyolefin in form of a polyolefin powder.

In some embodiments, step a) is preparing a multimodal polyethylene by homopolymerizing or copolymerizing ethylene. In some embodiments, comonomers in ethylene polymerization are up to 40 wt. % of C₃-C₈-1-alkenes. In some embodiments, the C₃-C₈-1-alkenes are selected from the group consisting of 1-butene, 1-pentene, 1-hexene, 1-octene, and mixtures thereof. In some embodiments, ethylene is copolymerized with from 0.01 wt. % to 20 wt. %, alternatively from 0.05 wt. % to 12 wt. %, of one or more C₃-C₈-1-alkenes. In some embodiments, the comonomers for the copolymerization of ethylene are 1-hexene, 1-butene, or both.

In some embodiments, the polyolefins are multimodal polyolefins. As used herein, the term “multimodal” refers to the modality of the molecular weight distribution. In some embodiments, the multimodal polyolefins are obtained from polymerizing or copolymerizing and one or more olefins in a series of two or more polymerization reactors under different reaction conditions. In some embodiments, the multimodal polyolefins are obtained by employing mixed catalyst system made from or containing two or more types of polymerization catalysts which produce, under the same polymerization conditions, polyolefins of a different molecular weight. As used herein, the term “modality” indicates how many different polymerization conditions were utilized in preparing the polyolefin, independently of (a) whether this modality of the molecular weight distribution is recognizable as separated maxima in a gel permeation chromatography (GPC) curve, or (b) how many different types of polymerization catalysts from which the mixed polymerization catalyst system is made or containing. As used herein, the term “multimodal” includes bimodal. In some embodiments, the polyolefin polymer has the molecular weight distribution and a comonomer distribution. In some embodiments, the average comonomer content of polymer chains having a comparably higher molecular weight is higher than the average comonomer content of polymer chains having a comparably lower molecular weight. In some embodiments, identical or similar reaction conditions in the polymerization reactors of a series of polymerization reactors prepare narrow molecular weight polyolefins. In some embodiments and when preparing multimodal polyolefins in a series of polymerization reactors operating at different reaction conditions, different residence times of individual polyolefin particles in different reactors yield polyolefin particles of different composition.

In some embodiments, the polymerization methods for preparing the multimodal polyolefins are selected from the group consisting of solution processes, suspension processes, and gas-phase processes. In some embodiments, the polymerization is a gas-phase polymerization, alternatively a gas-phase polymerization in gas-phase fluidized-bed reactors or multi-zone circulating reactors. In some embodiments, the polymerization is suspension polymerization, alternatively a solution polymerization in loop reactors or stirred tank reactors.

In some embodiments, the polymerizations for preparing the multimodal polyolefin are operated at pressures from 0.5 MPa to 10 MPa, alternatively from 1.0 MPa to 8 MPa, alternatively from 1.5 MPa to 4 MPa. As used herein, the term “pressure” refers to absolute pressures, that is, pressure having the dimension MPa (abs). In some embodiments, the polymerizations are carried out at temperatures from 30° C. to 160° C. alternatively from 65° C. to 125° C. In some embodiments, the temperatures are in the upper part of the range from 30° C. to 160° C. and prepare ethylene polymers of relatively high density. In some embodiments, temperatures are in the lower part of the range and prepare ethylene copolymers of lower density.

In some embodiments, the multimodal polyolefins are prepared by polymerizing the one or more 1-olefins in a series of two or more polymerization reactors. In some embodiments, at least one of the polymerization reactors is a gas-phase polymerization reactor. In some embodiments, the multimodal polyolefin is prepared in in a series of two or more gas-phase polymerization reactors, alternatively a series of two or more fluidized-bed reactors or a series including a multi-zone circulating reactor and one or more different gas-phase polymerization reactors. In some embodiments, the gas-phase polymerization reactors are fluidized-bed reactors. In some embodiments, the multimodal polyolefins are prepared in a series of first one or more suspension polymerization reactors and subsequently one or more gas-phase polymerization reactors. In some embodiments, the suspension polymerization reactors are loop reactors. In some embodiments, the gas-phase polymerization reactors are fluidized-bed reactors.

In some embodiments, at least one of the polymerization reactors of the series of polymerization reactors is a gas-phase polymerization reactor. In some embodiments, the gas-phase polymerization reactor has a riser unit, wherein growing polymer particles flow upwards under fluidization, fast fluidization, or transport conditions, and a downcomer, wherein growing polymer particles flow downward in a densified form.

In some embodiments, the riser unit includes a fluidized bed of growing polymer particles. In some embodiments, the riser unit operates as a thoroughly mixed gas-phase reactor such as a fluidized bed reactor. As described herein, fluidized-bed reactors are reactors, wherein the polymerization takes place in a bed of polymer particles and maintained in a fluidized state by feeding in a reaction gas mixture at the lower end of the reactor and taking off the gas again at the reactor's upper end. In some embodiments, feeding of the reaction gas mixture occurs below a gas distribution grid, having the function of dispensing the gas flow. The reaction gas mixture is then returned to the lower end to the reactor via a recycle line equipped with a compressor and a heat exchanger for removing the heat of polymerization. In some embodiments, the velocity of the reaction gas mixture fluidizes the mixed bed of finely divided polymer present in the tube serving as polymerization zone and removes the heat of polymerization.

In some embodiments, the downcomer is positioned within, around, or adjacent to the gas-phase reactor. In some embodiments, two or more separated polymerization units are used as the downcomer.

In some embodiments, the riser unit is a riser, wherein an upward movement of growing polymer particles occurs under fast fluidization or transport conditions. Fast fluidization conditions inside the riser are established by feeding a reaction gas mixture at a velocity higher than the transport velocity of the polymer particles. In some embodiments, the velocity of the reaction gas mixture is between 0.5 and 15 m/s, alternatively between 0.8 and 5 m/s. As used herein, the terms “transport velocity” and “fast fluidization conditions” are as defined in “D. Geldart, Gas Fluidization Technology, page 155 et seq., J. Wiley & Sons Ltd., 1986”.

As used herein, the part of the polymerization reactor, wherein the growing polymer particles flow downward in a densified form, is referred to interchangeably as “downcomer,” “moving bed.” or “settled bed” unit or reactor. As used herein, the term “densified form” refers to the ratio between the mass of polymer and the reactor volume being higher than 80% of the “poured bulk density” of the resulting polymer. For example and in terms of densified form, a polymer bulk density equal to 420 kg/m³ indicates a polymer mass/reactor volume ratio of at least 336 kg/m³. The “poured bulk density” of a polymer is measurable according to DIN EN ISO 60:1999. The density of solid inside the reactor is defined as the mass of polymer per volume of reactor occupied by the polymer.

In some embodiments, a downcomer is a part of the polymerization reactor containing a bed of growing polymer particles, which moves downwards in a plug flow mode. As used herein, the term “plug flow mode” refers to little or no backmixing of the polymer particles.

In some embodiments and for replacing reacted olefins and controlling the gas flow within the downcomer, gaseous or liquid feed streams are introduced at one or more positions into the downcomer. In some embodiments, the feed streams are made from or containing ethylene. In some embodiments, the feed streams are made from or containing ethylene one or more comonomers. In some embodiments, the feed streams are further made from or containing inert components or hydrogen. In some embodiments, the inert component is propane. In some embodiments, the gaseous medium surrounding the polymer particles move downwards concurrently with the polymer particles or upward countercurrently to the polymer particles. In some embodiments, the direction of movement for the gaseous medium is controlled by the amount of gaseous or liquid feed streams and pressure conditions. In some embodiments, liquid streams vaporize within the downcomer, thereby contributing to the composition of the reaction gas mixture within the downcomer. In some embodiments, the downcomer is operated with more than one feed stream. In some embodiments, the feeding points of the feed streams are evenly distributed over the height of the downcomer.

In some embodiments, one of the polymerization reactors is a multizone circulating reactor. In some embodiments, the reactors are as described in Patent Cooperation Treaty Publication Nos. WO 97/04015 A1 and WO 00/02929 A1. In some embodiments, the reactors have two interconnected polymerization zones, a riser, wherein the growing polymer particles flow upward under fast fluidization or transport conditions, and a downcomer, wherein the growing polymer particles flow in a densified form under the action of gravity. The polymer particles leaving the riser enter the downcomer, and the polymer particles leaving the downcomer are reintroduced into the riser, thereby establishing a circulation of polymer between the two polymerization zones. In some embodiments, the polymer is passed a plurality of times through these two zones. In some embodiments, a solid/gas separator is arranged above the downcomer, thereby separating the polyolefin and reaction gaseous mixture coming from the riser. In some embodiments, the growing polyolefin particles enter the downcomer, and the separated reaction gas mixture of the riser is continuously recycled through a gas recycle line to one or more points of reintroduction into the polymerization reactor. In some embodiments, more than half of the recycle gas is recycled to the bottom of the riser. In some embodiments, the recycle line is equipped with a compressor and a heat exchanger for removing the heat of polymerization. In some embodiments, a line for the catalyst feed is arranged on the riser, and a polymer discharge system is in the bottom portion of the downcomer. In some embodiments, make-up monomers, comonomers, hydrogen, or inert components are introduced at various points along the riser and the downcomer.

In some embodiments, the reaction gas mixture leaving the riser unit is partially or totally prevented from entering the downcomer, thereby establishing different polymerization conditions between the riser unit and at least a part of the downcomer. In some embodiments, the reaction gas mixture leaving the riser unit is partially or totally prevented from entering the downcomer by feeding a barrier fluid in form of a gas, liquid, or both mixture into the downcomer, alternatively in the upper part of the downcomer. In some embodiments, the composition of the barrier fluid differs from the composition of the gas mixture in the riser unit. In some embodiments, the amount of added barrier fluid is adjusted such that an upward flow of gas countercurrent to the flow of the polymer particles is generated and acts as a barrier to the gas mixture entrained with the particles coming from the riser unit. In some embodiments, the countercurrent occurs at the top of the riser unit.

In some embodiments, the barrier fluid comes from a recycle gas stream, alternatively obtained by partly condensing the stream. In some embodiments, the barrier fluid is made from or containing a combination of the monomers to be polymerized, inert compounds, hydrogen, and other components of the reaction gas mixture. In some embodiments, the inert compound is a polymerization diluent. In some embodiments, the inert compounds are selected from the group consisting of nitrogen and alkanes having from 1 to 10 carbon atoms.

In some embodiments, the polymerization in the gas-phase polymerization reactors of the series of polymerization reactors is carried out in a condensing or super-condensing mode, wherein part of the circulating reaction gas mixture is cooled to below the dew point and returned to the reactor separately as a liquid, separately as a gas-phase, or together as a liquid-gas phase mixture, thereby using the enthalpy of vaporization for cooling the reaction gas.

In some embodiments, wherein the series of polymerization reactors includes a gas-phase polymerization reactor includes a riser unit and a downcomer, the further polymerization reactors of the series of polymerization reactors are low-pressure polymerization reactors. In some embodiments, the low-pressure polymerization reactors are gas-phase reactors or suspension reactors. In some embodiments, the suspension polymerization is carried out upstream of the gas-phase polymerization. In some embodiments, the suspension polymerization is carried out in loop reactors or stirred tank reactors. In some embodiments, the suspension media are selected from the group consisting of inert hydrocarbons and the monomers. In some embodiments, the inert hydrocarbons are isobutane or mixtures of hydrocarbons. In some embodiments, additional polymerization stages, are carried out in suspension and include a pre-polymerization stage. In some embodiments, the multistage polymerization of olefins includes additional polymerization stages carried out in gas-phase. In some embodiments, the additional gas-phase polymerization reactors are horizontally or vertically stirred gas-phase reactors, fluidized-bed reactors, or multizone circulating reactors. In some embodiments, the additional gas-phase polymerization reactors are arranged downstream or upstream of the gas-phase polymerization reactor. In some embodiments, the gas-phase polymerization reactor, including the riser unit and the downcomer, is part of a series of polymerization reactors wherein a fluidized-bed polymerization reactor is arranged upstream of the gas-phase polymerization reactor.

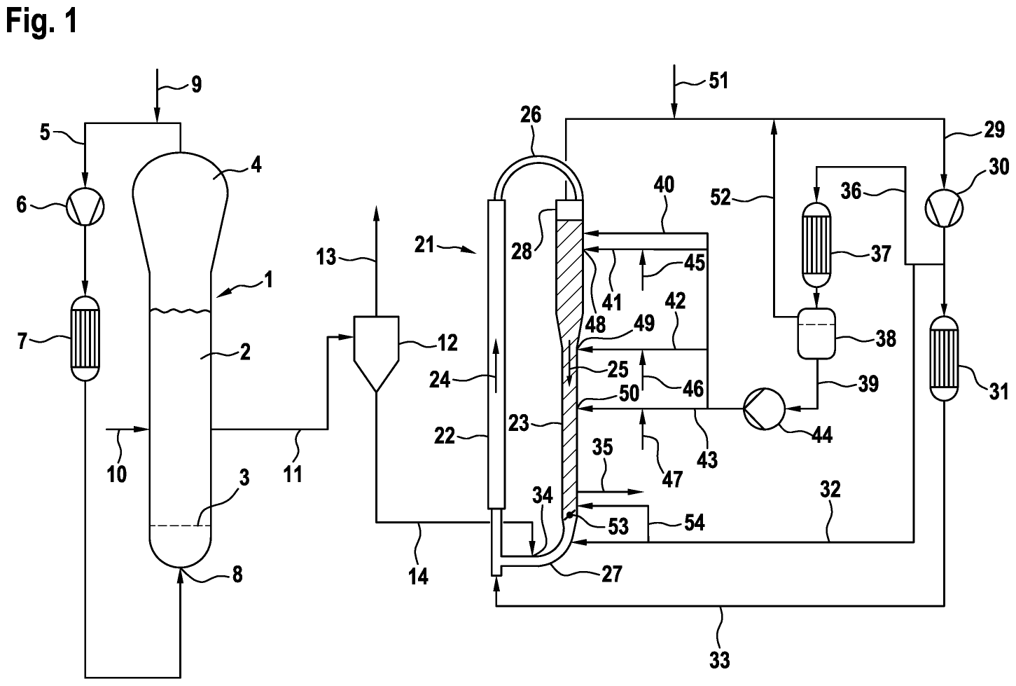

FIG. 1 shows a schematic of a series of polymerization reactors, including a fluidized-bed reactor and a multizone circulating reactor, for preparing a multimodal polyolefin.

The first gas-phase reactor, fluidized-bed reactor (1), includes a fluidized bed (2) of polyolefin particles, a gas distribution grid (3), and a velocity reduction zone (4). In some embodiments, the velocity reduction zone (4) is of increased diameter compared to the diameter of the fluidized-bed portion of the reactor. An upward flow of gas fed through the gas distribution grid (3), placed at the bottom portion of the reactor (1), keeps the polyolefin bed in a fluidized state. The gaseous stream of the reaction gas mixture leaving the top of the velocity reduction zone (4) via recycle line (5) is compressed by compressor (6), transferred to a heat exchanger (7), wherein the gaseous stream is cooled, and then recycled to the bottom of the fluidized-bed reactor (1) at a point below the gas distribution grid (3) at position (8). In some embodiments, the recycle gas is cooled to below the dew point of one or more of the recycle gas components in the heat exchanger, thereby operating the reactor with condensed material or in the condensing mode. In some embodiments, the recycle gas is made from or containing a combination of unreacted monomers, inert condensable gases, and inert non-condensable gases. In some embodiments, the inert non-condensable gas is nitrogen. In some embodiments, the inert condensable gases are alkanes. In some embodiments, make-up monomers, hydrogen, optional inert gases, or process additives are fed into the reactor (1) at various positions, alternatively via line (9) upstream of the compressor (6). In some embodiments, the catalyst is fed into the reactor (1) via a line (10). In some embodiments, line (10) is placed in the lower part of the fluidized bed (2).

The polyolefin particles obtained in fluidized-bed reactor (1) are discontinuously discharged via line (11) and fed to a solid/gas separator (12), thereby preventing entry of the gaseous mixture, coming from the fluidized-bed reactor (1), into the second gas-phase reactor. The gas leaving solid/gas separator (12) exits the reactor via line (13) as off-gas while the separated polyolefin particles are fed via line (14) to the second gas-phase reactor.

The second gas-phase reactor is a multizone circulating reactor (21), including a riser (22) and a downcomer (23) which are repeatedly passed by the polyolefin particles. Within riser (22), the polyolefin particles flow upward under fast fluidization conditions along the direction of arrow (24). Within the downcomer (23) and under the action of gravity, the polyolefin particles flow downward along the direction of the arrow (25). The riser (22) and the downcomer (23) are interconnected by the interconnection bends (26) and (27).

After flowing through the riser (22), the polyolefin particles and the reaction gas mixture leave riser (22) and are conveyed to a solid/gas separation zone (28). In some embodiments, solid/gas separation is effected by a centrifugal separator like a cyclone. From the separation zone (28), the polyolefin particles enter downcomer (23).

The reaction gas mixture leaving the separation zone (28) is recycled to the riser (22) via a recycle line (29), equipped with a compressor (30) and a heat exchanger (31). Between the compressor (30) and the heat exchanger (31), recycle line (29) splits. Accordingly, the gaseous mixture is divided into two streams: line (32) conveys a first part of the recycle gas into the interconnection bend (27) while line (33) conveys a second part of the recycle gas to the bottom of riser (22), thereby establishing fast fluidization conditions therein.

The polyolefin particles coming from the first gas-phase reactor via line (14) enter the multizone circulating reactor (21) at the interconnection bend (27) in position (34). The polyolefin particles obtained in multizone circulating reactor (21) are continuously discharged from the bottom part of downcomer (23) via the discharge line (35).

A part of the gaseous mixture leaving the separation zone (28) exits the recycle line (29) after having passed the compressor (30) and is sent through line (36) to the heat exchanger (37), where the part is cooled to a temperature at which the monomers and the optional inert gas are partially condensed. A separating vessel (38) is placed downstream of the heat exchanger (37). The separated liquid is withdrawn from the separating vessel (38) via line (39) and fed to downcomer (23) through lines (40), (41), (42) and (43) by pump (44), wherein the feed stream introduced via line (40) is supplied to generate the barrier for preventing the reaction gas mixture of the riser (22) from entering the downcomer (23). In some embodiments, a combination of make-up monomers, make-up comonomers, optionally inert gases, and optionally process additives is introduced via lines (45), (46) and (47) into lines (41), (42) and (43) and then fed into the downcomer (23) at monomer feeding points (48), (49) and (50). In some embodiments, a combination of make-up monomers, make-up comonomers, optionally inert gases, and optionally process additives are introduced into the recycle line (29) via line (51). The gaseous mixture obtained as gas-phase in the separating vessel (38) is recirculated to recycle line (29) through line (52).

The bottom of the downcomer (23) is equipped with a control valve (53) having an adjustable opening for adjusting the flow of polyolefin particles from downcomer (23) through the interconnection bend (27) into the riser (22). Above the control valve (53), amounts of a recycle gas mixture coming from the recycle line (29) through line (54) are introduced into the downcomer (23), thereby facilitating flow of the polyolefin particles through the control valve (53).

In some embodiments, the polymerization for preparing the multimodal polyolefin is carried out using Phillips catalysts based on chromium oxide, titanium-based Ziegler- or Ziegler-Natta-catalysts, single-site catalysts, or mixtures of such catalysts. In some embodiments, the polymerization catalyst is a Ziegler- or Ziegler-Natta-catalyst made from or containing the reaction product of an aluminum alkyl with a titanium compound supported on a magnesium halide.

In some embodiments, the multimodal polyolefin is obtained in the form of a polyolefin powder. As used herein, the term “powder” refers to particles having mass-median-diameter D50 in the range from 300 μm to 2500 μm, alternatively from 400 μm to 2300 μm, alternatively from 800 μm to 2100 μm, determined by dry sieving analysis according to DIN 53477 (November 1992).

In some embodiments, the multimodal polyolefins are multimodal polyethylenes having a density from 0.940 to 0.968 g/cm³. In some embodiments, the density is in the range from 0.945 to 0.965 g/cm³, alternatively from 0.945 to 0.955 g/cm³. As used herein, the term “density” refers to the density determined according to DIN EN ISO 1183-1:2004, Method A (Immersion) with compression molded plaques of 2 mm thickness which were pressed at 180° C., 20 MPa for 8 minutes with subsequent crystallization in boiling water for 30 minutes.

In some embodiments, the multimodal polyolefins are multimodal polyethylenes, having a melt flow rate MFR_{21.6} at 190° C. under a load of 21.6 kg, determined according to DIN EN ISO 1133:2005 condition G, from 0.5 to 300 g/10 min, alternatively from 1 to 100 g/10 min, alternatively from 1.2 to 100 g/10 min, alternatively from 1.5 to 50 g/10 min. In some embodiments, the multimodal polyethylenes have a M_{w}/Mₙ from 15 to 40, alternatively from 20 to 35, where M_{w} is the weight average molecular weight and Mₙ is the number average molecular weight, measured by GPC (Gel Permeation Chromatography). In some embodiments, the GPC is a high-temperature gel permeation chromatography carried out as described in ISO 16014-1, -2, -4, issues of 2003, wherein 1,2,4-trichlorobenzene (TCB) is used as solvent, the temperature of apparatus and solutions are 135° C., and an infrared detector capable for use with TCB is employed as a concentration detector.

In step b) of the process, an organic peroxide is provided in an amount from 20 ppm to less than 100 ppm, with respect to the polyolefin powder. In some embodiments, the organic peroxides are selected from the group consisting of dicumyl peroxide, di-tert-butyl peroxide, tert-butylperoxy benzoate, 2.5-dimethyl-2.5-di(tert-butylperoxy) hexane, 3,6,9-triethyl-3,6,9-trimethyl-1,2,4,5,7,8-hexoxonane, representatives of 3,6,9-trimethyl-3,6,9-tris(alkyl)-1,2,4,5,7,8-hexoxonanes wherein the alkyl radical is propyl or ethyl, tert-butyl peroxyneodecanoate, tert-amyl peroxypivalate, and 1,3-bis(tert-butylperoxyisopropyl)benzene. In some embodiments, the organic peroxide is selected from the group consisting of 2,5-dimethyl-2,5-di(tert-butylperoxy) hexane, 3,6,9-triethyl-3,6,9-trimethyl-1,2,4,5,7,8-hexoxonane, and representatives of 3,6,9-trimethyl-3,6,9-tris(alkyl)-1,2,4,5,7,8-hexoxonanes wherein the alkyl radical is propyl or ethyl.

In some embodiments, the organic peroxide is a polyolefin mixture or a solution in a diluent like a hydrocarbon to a polyolefin powder. In some embodiments, the polyolefin mixture is prepared by adding the organic peroxide in pure form. In some embodiments, the polyolefin mixtures have a content of the organic peroxide in the polyolefin mixture in the range from 0.5 to 25 wt. %, alternatively from 1 to 20 wt. %, alternatively from 2 to 10 wt. %.

In some embodiments, a liquid made from or containing an organic peroxide is provided in step b). In some embodiments, the liquid is a liquid peroxide or a solution of a peroxide. In some embodiments, the liquid is a solution of a peroxide. In some embodiments, the liquid is made from or containing an amount from 20 ppm to less than 100 ppm, alternatively from 25 ppm to 95 ppm, alternatively from 28 ppm to 80 ppm, alternatively from 40 ppm to 95 ppm, alternatively from 45 ppm to 95 ppm of organic peroxide, with respect to the polyolefin powder. In some embodiments, the liquid is added in such an amount that corresponds to an addition of from 20 ppm to less than 100 ppm, alternatively 25 ppm to 95 ppm, alternatively from 28 ppm to 80 ppm, alternatively from 40 ppm to 95 ppm, alternatively from 45 ppm to 95 ppm, of the organic peroxide. In some embodiments, the organic peroxide is employed in form of a solution in a diluent like a hydrocarbon. In some embodiments, the peroxide solutions have a content of active oxygen in the range from 0.1 wt. % to 10 wt. %, alternatively from 0.2 wt. % to 5 wt. %, alternatively from 0.3 wt. % to 2 wt. %, alternatively from 0.5 wt. % to 1 wt. %.

In some embodiments, some steps for preparing the polyolefin compositions are carried out in an extruder device. In some embodiments, the extruder devices are extruders or continuous mixers. In some embodiments, the extruders or mixers are single- or two-stage machines which melt and homogenize the polyethylene composition. In some embodiments, the extruders are pin-type extruders, planetary extruders, or co-rotating disk processors. In some embodiments, the extruders are combinations of mixers with discharge screws, gear pumps, or both. In some embodiments, the extruders are screw extruders, alternatively extruders constructed as twin-screw machine. In some embodiments, the extruders are selected from the group consisting of twin-screw extruders and continuous mixers with discharge elements. In some embodiments, the extruders are selected from the group consisting of continuous mixers with counter-rotating twin rotor and an extruder device having at least one co-rotating twin screw extruder. In some embodiment, the extruders are commercially available from Coperion GmbH. Stuttgart, Germany: KraussMaffei Berstorff GmbH, Hannover, Germany: The Japan Steel Works LTD., Tokyo, Japan: Farrel Corporation, Ansonia, USA: or Kobe Steel, Ltd., Kobe, Japan. In some embodiments, the extruder devices are equipped with units for pelletizing the melt, such as underwater pelletizers.

In some embodiments, the extruder device is a combination of a first and a second co-rotating twin-screw extruders, wherein the first twin-screw extruder receives the mixture made from or containing the polyolefin powder and the organic peroxide and forms a molten polymer stream and wherein the second twin-screw extruder receives the molten polymer stream and completes the homogenization process. In some embodiments, the polyethylene compositions are prepared in a counter-rotating continuous mixer equipped with gear pump or in a co-rotating twin screw extruder equipped with gear pump.

In step c), the polyolefin powder and the organic peroxide are mixed at a temperature in the range from 10° C. to 100° C., without melting the polyethylene powder. In some embodiments, the mixing of step c) is carried out at a temperature in the range from 20° C. to 90° C., alternatively from 60° C. to 80° C.

In some embodiments, the mixing of step c) is carried out in an atmosphere of reduced oxygen content. In some embodiments, the atmosphere of reduced oxygen content is achieved by injecting nitrogen into the mixing device. In some embodiments, the oxygen content in the gas phase within the mixing device is less than 5 vol %, alternatively less than 1 vol %, alternatively less than 0.2 vol %.

In some embodiments, the mixing of step c) is carried out in a mixing device. In some embodiments, the multimodal polyolefin and the organic peroxide are supplied to the mixing device for mixing. In some embodiments, the mixing device allows dry-blending of particles. In some embodiments, the mixing device operates continuously or discontinuously. In some embodiments, the mixing device operates continuously.

In some embodiments, dry-blending devices are paddle mixers having one or two horizontally orientated rotating shafts, alternatively two horizontally orientated counter-rotating shafts. In some embodiments, the rotating shafts move the composition of polyethylene powder and additives horizontally along the axis of the shafts and at the same time mix the composition intensively. In some embodiments, the paddle mixers are commercially available from Köllemann GmbH, Adenau, Germany or J. Engelsmann A G, Ludwigshafen, Germany. In some embodiments, the mixing devices are vertical batch mixers such as Henschel-Mixers& which are commercially available from Zeppelin Systems GmbH, Kassel, Germany. In some embodiments, the dry-blending devices are single screw conveyors equipped with blending elements. In some embodiments, the blending elements are amendable devices such as adjustable paddles or slotted flights, thereby controlling the level of blending.

In some embodiments, the mixing of step c) is carried out in the extruder device. In some embodiments, the multimodal polyolefin and the organic peroxide are supplied to the extruder device for mixing. In some embodiments, the polyolefin powder is transferred to a hopper of the extruder device and then introduced from the hopper into the extruder device. In some embodiments, the transfer of the polyolefin powder into the extruder device occurs by gravity. In some embodiments, the polyolefin powder is introduced into the extruder device in an atmosphere of reduced oxygen content. In some embodiments, the atmosphere of reduced oxygen content is achieved by injecting nitrogen into the hopper. In some embodiments, the oxygen content in the gas phase within the hopper is less than 5 vol %, alternatively less than 1 vol %, alternatively less than 0.2 vol %.

In some embodiments, the organic peroxide is provided in liquid form. In some embodiments, the liquid made from or containing the organic peroxide is added to the polyethylene powder by passing the liquid with an injection pressure of from 0.5 to 4 MPa, alternatively from 1 to 2 MPa, through a spring injector, having a preloaded spring, and feeding the liquid into the mixing device or into the extruder device.

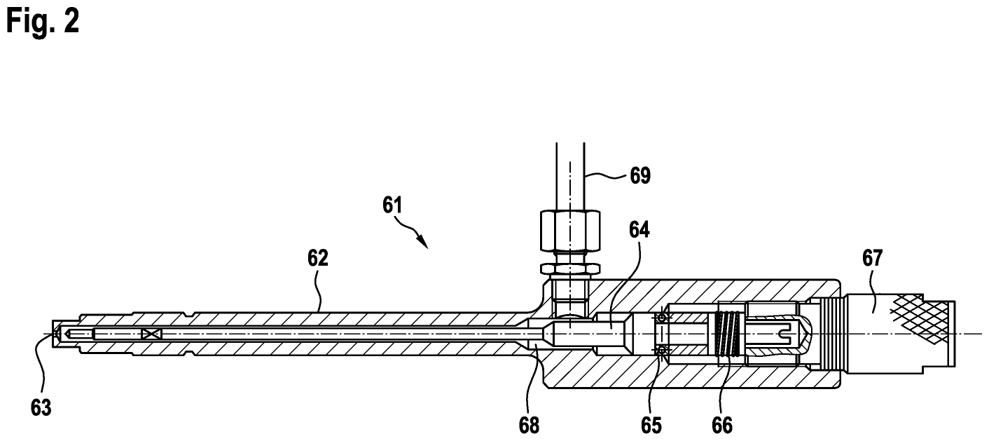

FIG. 2 shows a schematic of a spring injector for adding a liquid made from or containing an organic peroxide to a polyethylene powder. The spring injector (61) has a body (62), an injection orifice (63), an internal needle (64), a sealing device (65), a compression spring (66), a compression adjustment knob (67) for setting the spring preload, and an injection chamber (68). In some embodiments, the liquid is continuously fed through feeding pipe (69) into the injection chamber (68). Compression spring (66) pushes the needle (64) against the injection orifice (63) according to the preload of compression spring (66). Once the pressure within the injection chamber (68) overcomes the preload on the compression spring (66), the peroxide solution is finely sprayed over the polyethylene powder. Additionally, the preload of the compression spring (66) prevents powdery material, such as polyethylene fines or additives, from entering the injection chamber (68) and related blockings.

Within the extruder device, in step d), the polyolefin peroxide mixture is melted and homogenized to form a molten polyolefin composition. In some embodiments, the melting and homogenizing is achieved by applying heat and mechanical energy to the polyolefin peroxide mixture. In some embodiments, the conditions within the extruder device and the chemical structure of the organic peroxide are selected such that at least 90 wt. %, alternatively at least 95 wt. %, alternatively from 98 wt. % to 100 wt. %, of the organic peroxide decomposes.

Subsequently, in step e), one or more antioxidants are added to the molten polyolefin composition, thereby forming a combination of molten polyolefin composition and antioxidant.

Subsequent step f) is a step of homogenizing the combination of molten polyolefin composition and antioxidant, thereby forming an antioxidant equipped molten polyolefin composition. Step f) results in a further homogenization of the polyolefin melt and provides uniform distribution of the antioxidants within the polyolefin melt.

In some embodiments, the extruder device is a combination of a first and a second co-rotating twin-screw extruders, wherein the first twin-screw extruder receives the polyolefin powder and the organic peroxide, carries out step d), and forms the molten polyolefin composition, and wherein the second twin-screw extruder receives a stream of the molten polyolefin composition and carries out step f). In some embodiments, the extruder device is a counter-rotating continuous mixer equipped with gear pump or a co-rotating twin screw extruder equipped with gear pump.

In some embodiments, the specific energy, that is, the combined amount of heat and mechanical energy per amount of material being processed, is applied in steps d) and f) and is from 120 kWh/t to 350 kWh/t, alternatively from 160 kWh/t to 300 kWh/t, alternatively from 200 kWh/t to 260 kWh/t.

In some embodiments, the antioxidant equipped molten polyolefin composition is passed through a melt filter before being pelletized. In some embodiments, the melt filters have one or more active screens having a mesh opening from 50 μm to 400 μm. In some embodiments, the melt filters have one or more active screens having a mesh opening from 75 μm to 200 μm. In some embodiments, the melt filters have at least two screens having a mesh opening from 205 μm to 350 μm. In some embodiments, the combinations of screens are as described in Patent Cooperation Treaty Publication No. WO 2012/152775 A1.

Subsequent step g) provides pelletizing of the antioxidant equipped molten polyethylene composition. Step g) accordingly transforms the molten polyethylene composition into pellets.

In some embodiments, the polyolefin compositions are further made from or containing additives. In some embodiments, the additives are selected from the group consisting of melt stabilizers, light stabilizers, acid scavengers, lubricants, processing aids, antiblocking agents, slip agents, antistatics agents, antifogging agents, pigments or dyes, nucleating agents, flame retardants, and fillers. In some embodiments, the polyolefin composition is further made from or containing several additives. In some embodiments, the multiple additives are different types of additives. In some embodiments, several representatives of the same type of additives are added to the polyolefin composition. In some embodiments, the additives are commercially available and as described in Hans Zweifel, Plastics Additives Handbook, 5th Edition, Munich, 2001.

In some embodiments, the further additives, which are different from antioxidants and organic peroxides, are added in step e) together with the one or more antioxidants to the molten polyolefin composition obtained in step d).

In some embodiments, the multimodal polyolefin and the further additives are supplied to a mixing device and are mixed therein, thereby forming a polyolefin powder mixture, without melting the polyolefin powders. In some embodiments, the organic peroxide is also supplied to the mixing device. As such, the mixing in the mixing device represents step c) of the process. In some embodiments, no organic peroxide is supplied to the mixing device; the further additives and the polyolefin powder are mixed in the mixing device, thereby forming a polyolefin powder additive mixture; the polyolefin powder additive mixture is transferred from the mixing device into the extruder device; and the organic peroxide is supplied to the extruder device. As such, step c) is a mixing of the organic peroxide with the polyolefin powder additive mixture within the extruder device at a position where the polyolefin powder additive mixture is not yet molten.

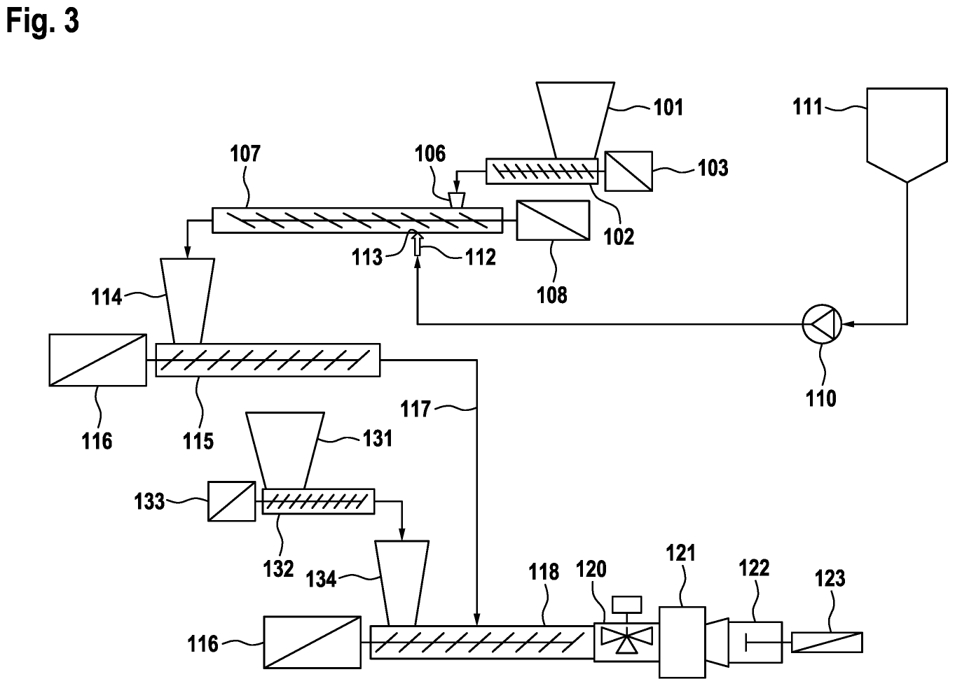

FIG. 3 shows a schematic of a process for preparing a polyolefin composition, wherein a liquid made from or containing an organic peroxide is added to a polyolefin powder in a mixing device and a masterbatch of one or more antioxidants is added to the molten and homogenized mixture of polyolefin powder and peroxide solution.

Polyolefin powder is provided to hopper (101) of a dosing device (102), which is operated by a motor (103). Dosing device (102) feeds the polyolefin powder to a hopper (106) of a screw conveyor (107), which is operated by a motor (108). A peroxide solution is transferred by a pump (110) from a storage vessel (111) to the screw conveyor (107) and injected through injector (112) into the screw conveyor (107) at a position (113) downstream of hopper (109), thereby forming a mixture of polyolefin powder and peroxide solution.

Screw conveyor (107) feeds the mixture to a hopper (114) of a first extruder (115), which is operated by a motor (116). Within extruder (115), the mixture is melted and homogenized and the peroxide decomposes, thereby forming a molten polyolefin composition.

Extruder (115) feeds the molten polyolefin composition via a line (117) into a second extruder (118), which is operated by a motor (119). A masterbatch prepared from one or more antioxidants and the polyolefin powder is provided to hopper (131) of dosing device (132), which is operated by a motor (133). Dosing device (132) feeds the masterbatch to a hopper (134) of the second extruder (118). Within extruder (118), the masterbatch feed to hopper (134) is melted, thereby forming a molten masterbatch, and mixed with the molten polyolefin composition provided by extruder (115). Also within extruder (118), the mixture of the molten masterbatch and the molten polyolefin composition is homogenized. The homogenized melt is passed through a startup valve (120) and a melt filter (121) and transferred into an underwater pelletizer (122), operated by a motor (123), for forming pellets.

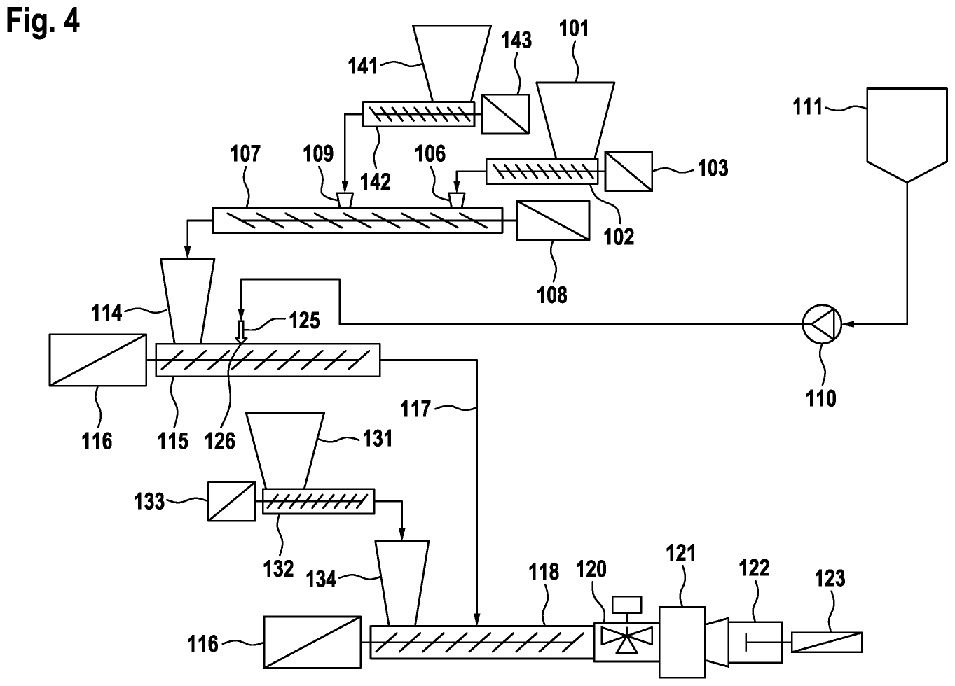

FIG. 4 shows a schematic of a process for preparing a polyolefin composition, wherein a liquid made from or containing an organic peroxide is added to a polyolefin powder in an extruder device and a masterbatch of one or more antioxidants is added to the molten and homogenized mixture of polyolefin powder and peroxide solution.

The schematic shown in FIG. 4 is identical with the schematic shown in FIG. 3, except that the peroxide solution is transferred by pump (110) from storage vessel (111) to the first extruder (115) and injected through injector (125) into extruder (115) at a position (126) downstream of hopper (114) where the polyolefin powder is not yet molten. Furthermore, a mixture of additives, which are neither an organic peroxide nor an antioxidant, is provided to hopper (141) of a further dosing device (142), which is operated by a motor (143). Dosing device (142) feeds the mixture of additives to a hopper (109) of screw conveyor (107), which is located downstream of hopper (106).

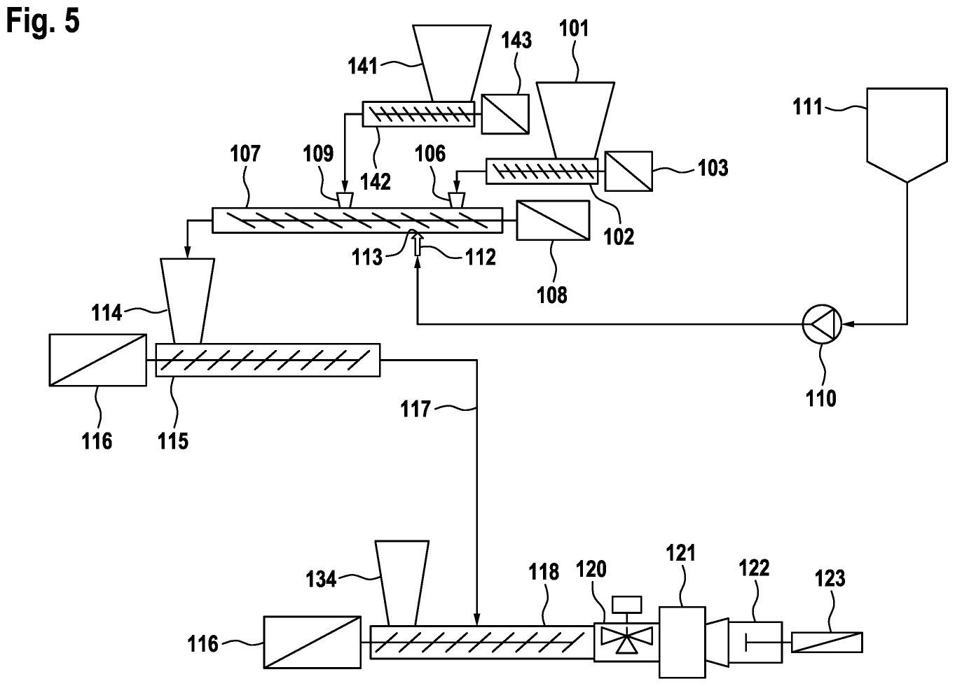

FIG. 5 shows a schematic of a process for preparing a polyolefin composition, wherein a liquid made from or containing an organic peroxide and a mixture of additive made from or containing one or more antioxidants are added to a polyolefin powder in a mixing device.

In some embodiments, the present disclosure provides a process for preparing a pipe including the steps of a) preparing a polyolefin composition and b) forming the polyolefin composition into a pipe. In some embodiments, the pipe has a SAG value of from 10 to 17.

### EXAMPLES

The melt flow rate MFR₅ was determined according to DIN EN ISO 1133-1:2012-03 at a temperature of 190° C. under a load of 5 kg.

The SAG values were determined in a rotational parallel plate rheometer with a shear stress of 300 Pa for 5200 seconds at 230° C. with plate opening of 1 mm. The SAG values are defined as 1/10th of a percent of creep strain measured at the end of the test. It is believed that lower SAG values correspond to a more uniform pipe thickness.

The gel count and gel area were determined by preparing a cast film, analyzing the film defects by an optical scanning device, and classifying and counting the film defects according to size (circle diameter). The films were prepared by an extruder (type Collin 25) equipped with a chill roll and winder (model Collin Chill Roll 144/230) and analyzed by an optical film surface analyzer with flash camera system, model FSA100 (produced by OCS Optical Control Systems GmbH, Witten, Germany). The apparatus had the following characteristics
screw diameter: 25 mm;
screw length: 25 D;
compression ratio: 3.5:1;
screw layout 27 D: 9 D feeding, 7 D compression, 9 D metering;
die width (slit die): 150 mm;
resolution: 25 μm×25 μm;
and was operated under the following conditions
T 1 200° C.;
T 2 210° C.;
T 3 220° C.;
T 4,5 (adapter) 230° C.;
T 6,7,8 (die) 240° C.;
take off speed 3.0 m/min;
screw speed to be adjusted to film thickness 50 μm;
throughput 1.0 to 1.5 kg/h (target 1.15 kg/h);
air shower ON,
chill roll temperature 60° C.;
camera threshold threshold 1: 50%-threshold 2: 45%.
   For starting the measurement, extruder and take off unit were set to the conditions and started with a standard material having a certain gel level. The film inspection software was started when the extruder showed steady conditions of temperature and melt pressure. After having operated the extruder with the starting material for at least half an hour or after the gel count having reached the certain gel level, the first sample to measure was fed to the extruder. After reaching a stable gel level for 45 minutes, the counting process was started until the camera had inspected an area of at least 3 m² of film. Thereafter, the next sample was fed to the extruder. After reaching a stable gel count for 45 minutes, the counting process for the next sample was started. The counting process was set for the samples such that the camera inspected an area of at least 3 m² of film and the number of measured defects per size-class was normalized to 1 m² of film.

The determination of the particle size distribution was carried out by dry sieving analysis according to DIN 53477 (November 1992) using a AS 200 control vibratory sieve shaker (Retsch GmbH, Haan, Germany) with a set of 7 calibrated sieves (125 μm, 250 μm, 500 μm, 710 μm, 1000 μm, 1400 μm, and 2000 μm). The mass-median-diameter D50 of the polyolefin particles was obtained by calculating the particle size distribution using the software Easy Sieve 4.0 of the apparatus, after weighing the fractions on each sieve.

### Example 1

A polyethylene was prepared in a series of a fluidized-bed reactor and a multizone circulating reactor (MZCR) having two interconnected reaction zones, as shown in FIG. 1.

12 g/h of a Ziegler-Natta catalyst, which was prepared according to Example 6 of Patent Cooperation Treaty Publication No. WO2018/114453 A1, were fed using 0.7 kg/h of liquid propane to a first stirred precontacting vessel, into which additionally triisobutylaluminum (TIBA) and diethylaluminum chloride (DEAC) were dosed. The weight ratio of TIBA to DEAC was 7:1. The weight ratio of the aluminum alkyls to the catalyst solid was 5:1. The first precontacting vessel was kept at 50° C. with a residence time of 30 minutes. The catalyst suspension of the first precontacting vessel was continuously transferred to a second stirred precontacting vessel, which was operated with a residence time of 30 minutes and kept at 50° C. The catalyst suspension was then transferred continuously to a fluidized-bed reactor (1) via line (10).

In the fluidized-bed reactor (1), ethylene was polymerized in the presence of propane as an inert diluent and hydrogen as molecular weight regulator. 50 kg/h of ethylene and 230 g/h of hydrogen were fed to the fluidized-bed reactor (1) via line (9). No comonomer was added. The polymerization was carried out at a temperature of 80° C. and a pressure of 2.9 MPa.

The polyethylene obtained in the fluidized-bed reactor (1) had an MFR_{2.16} of 80 g/10 min and a density of 0.967 g/cm³.

The polyethylene obtained in the fluidized-bed reactor (1) was continuously transferred to a multizone circulating reactor (21), which was operated at a pressure of 2.5 MPa and a temperature of 80° C., measured at the beginning of line (29), after the reaction gas mixture entered from separation zone (28). The riser (22) had an internal diameter of 200 mm and a length of 19 m. The downcomer (23) had a total length of 18 m, divided into an upper part of 5 m with an internal diameter of 300 mm, a lower part of 13 m with an internal diameter of 150 mm and in-between the upper part and the lower part a conical part having a length of 0.43 m. The final polymer was discontinuously discharged via line (35).

50 kg/h of a liquid stream were fed as barrier fluid into the upper part of the downcomer (23) via line (40). The liquid for generating the barrier originated from partially condensing recycle gas mixture in heat exchanger (37) at working conditions of 60° C. and 2.5 MPa and separating liquid and gaseous components in separating vessel (38). The liquid barrier fluid had a composition that the gas produced by vaporizing the barrier fluid had 4.2 vol. % ethylene, 0.02 vol. % hydrogen, 0.6 vol. % 1-hexene, and 95.18 vol. % propane.

Additional monomers were fed to the downcomer at three monomer feeding points below the barrier. The combined quantity of fresh monomers fed into the downcomer (23) were 20 kg/h of ethylene and 1.7 kg/h of 1-hexene. Additionally. 5 kg/h of propane. 25.5 kg/h of ethylene, and 1.3 g/h of hydrogen were fed through line (51) into the recycle line (29).

Of the polyethylene finally obtained in the series of the fluidized-bed reactor (1) and the multizone circulating reactor (21), 51% by weight were produced in the fluidized-bed reactor (1) and 49% by weight were produced in the multizone circulating reactor (21).

The finally obtained polyethylene had an MFR₅ of 0.21 g/10 min and a density of 0.948 g/cm³. The mass-median-diameter D50 of the polyethylene powder was 1624 μm.

### Example 2

The polyethylene powder prepared in Example 1 was metered, as shown in FIG. 3, at a feeding rate of 180.93 kg/h to a screw conveyor, commercially available from Somef Officina Meccanica E Fonderia, Occhiobello, Italia. In addition, an homogeneous solution of 8 wt. % 2,5-dimethyl-2,5-di-(tert.-butylperoxy)-hexane (Peroxan HX, commercially-available from PERGAN GmbH, Bocholt, Germany) and 92 wt. % paraffinic oil OB 22 AT (commercially available from Conqord Oil S.R.L., Castellar Guidobono, Italy), resulting in a solution containing 0.808 wt. % of active oxygen, was metered to the screw conveyor by a liquid dosing pump, commercially available from Lewa GmbH, Leonberg. Germany, using a liquid injector, as shown in FIG. 2, commercially available from Coperion GmbH, Stuttgart, Germany, with an injection pressure of 1 MPa. The added amount of the peroxide solution was at 500 ppm by weight (corresponding to 40 ppm by weight of 2,5-dimethyl-2,5-di-(tert.-butylperoxy)-hexane) with respect to the final polyethylene composition. To prevent the presence of oxygen, nitrogen was injected into the screw conveyor at a feed rate of 0.5 m³/h.

The homogenous mixture made from or containing polyethylene powder and peroxide generated by the screw conveyor mixer was then fed to the feeding hopper of the twin-screw extruder ZSK 50 of a ZSK NT 50/58 extrusion line (commercially available from Coperion GmbH, Stuttgart, Germany) having a first twin-screw extruder ZSK 50 and a second twin-screw extruder ZSK 58. In the ZSK 50 extruder, the mixture was melted and homogenized.

Polyethylene powder, Songnox 1010 (commercially available from SONGWON Industrial Co., Ltd., Ulsan, South Korea), Irgafos 168 (commercially available from BASF SE, Ludwigshafen, Germany), and Calcium Stearate “M” (commercially available from So.G.I.S. Industria Chimica Spa, Sospiro, Italy) were extruded by a Berstorff ZE25 twin screw extruder (commercially available from KraussMaffei Group GmbH, Munich, Germany), thereby forming an homogeneous masterbatch made from or containing 80% of powder prepared in Example 1 and 20% of additives. The obtained masterbatch of additives was fed as shown in FIG. 3 directly to the ZSK 58 twin screw extruder, the second stage of the ZSK NT 50/58 extrusion line, with a feeding rate of 4.07 kg/h. The amounts of added additives correspond to a content of additives in the final polyethylene composition of 1600 ppm by weight Songnox 1010, 1600 ppm by weight Irgafos 168, and 1200 ppm by weight Calcium Stearate M.

In the extruder ZSK 58, the mixture of masterbatch and polyethylene melt provided from the ZSK 50 extruder was then subjected to further homogenization and melt filtering steps. The mixture was pelletized, using a Filtec UW50 underwater pelletizing system (commercially available from Filtec srl, Badia Polesine, Italy). For melt filtering, the melt was passed through a screen pack composed of three 60 mesh metallic nets and a 20 mesh metallic net, acting as mechanical support.

The applied operating conditions and the results of the characterizations of the obtained pellet samples are indicated in Table 1.

### Comparative Example A

The process of Example 2 was repeated at the same conditions, except a masterbatch of the additives was not first prepared and fed to the ZSK 58 twin screw extruder as shown in FIG. 3. Instead, as shown in FIG. 5, the Songnox 1010, the Irgafos 168, and the Calcium Stearate “M” were mixed by a Mixaco LAB high speed mixer (commercially available from MIXACO Maschinenbau, Neuenrade, Germany), thereby forming a homogeneous powder premix. The additive powder premix, the polyethylene powder, and the peroxide solution were metered to the screw conveyor, at two different feeding points, and intimately mixed therein. The homogenous mixture of polyethylene powder, additives, and peroxide generated by the screw conveyor mixer was then fed to the feeding hopper of the ZSK 50 extruder of the ZSK NT 50/58 extrusion line. The content of additives in the final polyethylene composition was the same as that of Example 2, as well as the added amount of 2,5-dimethyl-2,5-di-(tert.-butylperoxy)-hexane, which was 40 ppm by weight.

The applied operating conditions and the results of the characterizations of the obtained pellet samples are indicated in Table 1.

### Comparative Example B

The process of Comparative Example A was repeated at the same conditions, except the added amount of 2,5-dimethyl-2,5-di-(tert.-butylperoxy)-hexane was at 80 ppm by weight (corresponding to 1000 ppm by weight of peroxide solution) with respect to the final polyethylene composition.

The applied operating conditions and the results of the characterizations of the obtained pellet samples are indicated in Table 1.

TABLE 1

| | | Comparative | Comparative |
|---|---|---|---|
| | Example 2 | Example A | Example B |
| Peroxide [ppm by weight] | 40 | 40 | 80 |
| Production rate [kg/h] | 185 | 185 | 185 |
| Specific production rate | 949 | 949 | 949 |
| [kg/h/dm³] | | | |
| ZSK 50 screw speed [rpm] | 280 | 280 | 280 |
| ZSK 58 screw speed [rpm] | 100 | 100 | 100 |
| Melt temperature at end of ZSK | 241 | 238 | 239 |
| 50 [° C.] | | | |
| Melt temperature at end of ZSK | 298 | 294 | 297 |
| 58 [° C.] | | | |
| ZSK NT 50/58 specific energy | 293 | 289 | 286 |
| [kWh/t] | | | |
| MFR₅ [g/10 min] | 0.14 | 0.22 | 0.17 |
| SAG value | 11.8 | 21.9 | 12.8 |
| Gel >700 μm [1/m²] | 13 | 49 | 69 |

The comparison between Example 2 and Comparative Example A shows that preparing a multimodal polyethylene composition according to the process of the present disclosure by adding the antioxidants Songnox 1010 and Irgafos 168 to a molten polyethylene composition which is obtained from melting and homogenizing a mixture of a multimodal polyethylene in form of a polyethylene powder and an organic peroxide results in a multimodal polyethylene composition which has a very low level of large gels and which allows to prepare pipes have a high resistance to sagging. In contrast, when using the same multimodal polyethylene powder and the same amounts of peroxide and antioxidants but adding the antioxidants together with the peroxide to the polyethylene powder, the sagging behavior is drastically deteriorated and the amount of large gels has increased. The comparison between Comparative Example A and Comparative Example B further shows that increasing the amount peroxide at identical process conditions improves the resistance to sagging, however at the cost of an even increased level of large gels.

1. A continuous process for preparing a multimodal polyolefin composition comprising one or more antioxidants, comprising the steps of:
a) preparing a multimodal polyolefin in form of a polyolefin powder having a mass-median-diameter D50 in the range from 300 μm to 2500 μm, in a series of two or more polymerization reactors by polymerizing one or more 1-olefins in the presence of an olefin polymerization catalyst at pressures from 0.5 MPa to 10 MPa and temperatures from 30° C. to 160° C., wherein the multimodal polyolefin being a multimodal polyethylene;
b) providing an organic peroxide in an amount from 20 ppm to less than 100 ppm, with respect to the polyolefin powder;
c) mixing the polyolefin powder and the organic peroxide at a temperature in the range from 10° C. to 100° C., without melting the polyolefin powder, thereby forming a polyolefin peroxide mixture;
d) melting and homogenizing the polyolefin peroxide mixture within an extruder device, wherein at least 90 wt. % of the organic peroxide decomposes, thereby forming a molten polyolefin composition;
e) adding one or more antioxidants to the molten polyolefin composition, thereby forming a combination of molten polyolefin composition and antioxidant;
f) homogenizing the combination of molten polyolefin composition and antioxidant, thereby forming an antioxidant equipped molten polyolefin composition; and
g) pelletizing the antioxidant equipped molten polyolefin composition.

2. The process of claim 1, wherein the multimodal polyolefin is prepared in one or more gas-phase polymerization reactors, wherein at least one of the gas-phase polymerization reactors is a multizone circulating reactor, having a polymerization zone as a riser, wherein growing polymer particles flow upwards under fast fluidization or transport conditions, and other polymerization zones as sub-zones of a downcomer, wherein the growing polymer particles flow downward in a densified form, wherein the riser and the downcomer are interconnected, polymer particles leaving the riser enter the downcomer, and polymer particles leaving the downcomer enter the riser, thereby establishing a circulation of polymer particles through the riser and the downcomer.

3. The process of claim 2, wherein the series of polymerization reactors comprises a fluidized-bed reactor upstream of the multizone circulating reactor.

4. The process of claim 1, wherein the olefin polymerization catalyst is a Ziegler- or Ziegler-Natta-catalyst comprising the reaction product of an aluminum alkyl with a titanium compound supported on a magnesium halide.

5. The process of claim 1, wherein the extruder device is a combination of two co-rotating twin-screw extruders, wherein the polyolefin powder and the organic peroxide are transferred into a first twin-screw extruder, in which step d) is carried out, and the second twin-screw extruder receives the combination of molten polyolefin composition and antioxidant and carries out step f), or the extruder device is a counter-rotating continuous mixer equipped with gear pump or a co-rotating twin screw extruder equipped with gear pump.

6. The process of claim 1, wherein the antioxidant equipped molten polyolefin composition is passed through a melt filter before being pelletized.

7. The process of claim 1, wherein the multimodal polyolefin and the organic peroxide are supplied to a mixing device and the mixing of step c) occurs in the mixing device.

8. The process of claim 1, wherein the multimodal polyolefin is
(i) supplied directly to the extruder device or
(ii) supplied to a mixing device, mixed therein with one or more additives different from antioxidants and organic peroxides, thereby forming a mixture, and the mixture is transferred from the mixing device into the extruder device,
wherein the organic peroxide provided in step b) is supplied to the extruder device at a position where the multimodal polyolefin or the mixture is not yet molten.

9. The process of claim 1, wherein the mixing of step c) is carried out in an atmosphere of reduced oxygen content and the oxygen content in the gas phase within the mixing device is less than 5 vol %.

10. The process of claim 1, wherein in step b), the organic peroxide is provided as a liquid or as a component of a liquid or the organic peroxide is provided in form of a mixture of the organic peroxide with a polyolefin powder.

11. The process of claim 1, wherein in step b), the organic peroxide is provided as a liquid or as a component of a liquid, and the liquid is added to the polyethylene powder by injecting the liquid with an injection pressure of 0.5 to 4 MPa through a spring injector comprising a preloaded spring.

12. The process of claim 11, wherein the organic peroxide is provided as a peroxide solution, having a content of active oxygen in the range from 0.1 wt. % to 10 wt. %.

13. The process of claim 1, wherein the multimodal polyolefin has a Mw/Mn from 15 to 40.

14. The process of claim 1, wherein the multimodal polyolefin is a multimodal polyethylene, having a density determined according to DIN EN ISO 1183-1:2004 at 23° C. from 0.940 g/cm³ to 0.968 g/cm³.

15. A process for preparing a pipe comprising the steps of:
a) preparing a multimodal polyolefin composition by the process of claim 1; and
b) forming the multimodal polyolefin composition into a pipe.
